(19) United States
(12) Patent Application Publication
(10) Pub. No.: US 2025/0028639 A1
(43) Pub. Date: Jan. 23, 2025

(54) Method, Apparatus and System for Graph Data Caching

(71) Applicant: Siemens Aktiengesellschaft, München (DE)

(72) Inventor: Wen Ke Wang, Beijing (CN)

(73) Assignee: Siemens Aktiengesellschaft, München (DE)

(21) Appl. No.: 18/687,473

(22) PCT Filed: Aug. 30, 2021
(86) PCT No.: PCT/CN2021/115447

§ 371 Date: Feb. 28, 2024

(51) Int. Cl. G06F 12/0802

(52) U.S. Cl. CPC G06F 12/0802; G06F 2212/60

(57) ABSTRACT

Various embodiments of the teachings herein include a method for graph data caching. An example method includes: receiving a first semantic query on graph data; extracting, from the first semantic query, each first value of at least one semantic element; matching the first semantic query with at least one second semantic query stored in the cache based on each first value of the at least one semantic element; if the first semantic query has a match, achieving graph data linked with the at least one matched second semantic query from the cache, otherwise, achieving graph data from a database; and storing, in the cache, the first semantic query and the achieved graph data, wherein the first semantic query is linked with the achieved graph data.

### CROSS-REFERENCE TO RELATED APPLICATIONS

This application is a U.S. National Stage Application of International Application No. PCT/CN2021/115447 filed Aug. 30, 2021, which designates the United States of America, the contents of which are hereby incorporated by reference in their entirety.

### TECHNICAL FIELD

The present disclosure relates to data caching technology. Various embodiments of the teachings herein include methods, apparatus, system, and computer-readable storage media for graph data caching.

### BACKGROUND

In-memory caching system may improve the application performance. It usually caches commonly used data in memory as key-value data that are expected to be reused in future. Graph data, such as knowledge graph data, represents complex relationships among objects through vertices and edges. The graph algorithms require a lot of irregular data access patterns. It is difficult to achieve a high cache data hit rate to use traditionally key-value based caching system for graph data.

### SUMMARY

Some embodiments of the teachings of the present disclosure include a method for graph data caching, which includes: receiving a first semantic query on graph data; extracting, from the first semantic query, each first value of at least one semantic element; matching the first semantic query with at least one second semantic query stored in the cache based on each first value of the at least one semantic element; if matches, achieving the graph data linked with at least one matched second semantic query from the cache, otherwise, achieving the graph data from a database; and storing, in the cache, the first semantic query and the achieved graph data, wherein the first semantic query is linked with the achieved graph data.

As another example, some embodiments include an apparatus for graph data caching, which includes units executing one or more of the methods described herein.

As another example, some embodiments include an apparatus for graph data caching, which includes at least one processor, at least one memory coupled to the at least one processor, storing computer-executable instructions, wherein the computer-executable instructions when executed cause the at least one processor to execute one or more of the methods described herein.

As another example, some embodiments include a computer-readable medium for graph data caching storing computer-executable instructions, wherein the computer-executable instructions when executed cause at least one processor to execute one or more of the methods described herein.

As another example, some embodiments include a computer programming product with computer-readable instructions, wherein the computer-executable instructions cause at least one processor to execute one or more of the methods described herein. As another example, some embodiments include a system for graph data caching with a cache, a database and an apparatus as described herein.

### BRIEF DESCRIPTION OF THE DRAWINGS

The above-mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 depicts a system for graph data caching incorporating teachings of the present disclosure;

FIG. 2 depicts an apparatus for graph data caching incorporating teachings of the present disclosure;

FIG. 3 depicts a flow diagram of a method for graph data caching incorporating teachings of the present disclosure;

FIG. 4 depicts interaction between modules in the apparatus for graph data caching during data query incorporating teachings of the present disclosure; and

FIG. 5 depicts interaction between modules in the apparatus for graph data caching during database update incorporating teachings of the present disclosure.

### REFERENCE NUMBERS

100, a system for graph data caching
10, an apparatus for graph data caching
20, data sources
31, a first semantic query
32, a second semantic query
41, data loader
42, knowledge collector
43, graph database accessor
117, graph database
116, cache
101, at least one processor
102, at least one memory
103, a communication module
11, a graph data caching program
50, an external system
111, a receiving unit
111a, an API
111b, a service
112, a semantic parser
113, a query analyzer
114, a query executor
115, a cache manager
118, metadata controller
119, index manager
200, a method for graph data caching
S201˜S214, steps of method 200

### DETAILED DESCRIPTION

In the context of the semantic-based graph data caching solutions described herein, application scenarios of graph are considered to cache the graph data based on extracted semantic metadata from graph queries. The new semantic query will be matched with stored queries in the cache based on values of semantic elements. If it matches, graph data will be achieved directly from the cache, which accelerates significantly data access speed. The matching is based on values of extracted semantic elements, which function as combined key words for graph data indexing and searching. The solution is applicable to complicated graph data. Furthermore, the achieved graph data together with the new semantic query will be linked and stored in the cache for further graph data query.

In some embodiments, the first semantic query can be matched with at least one second semantic query stored in the cache based on each first value of the at least one semantic element and each second value of the least one semantic element of each second semantic query; and in the cache, the first semantic query is marked by each first value. In some embodiments, before matching the first semantic query with at least one second semantic query, each first value of the at least one semantic element can be mapped on first semantic metadata, wherein semantic metadata comprises the at least one semantic element, then the first semantic query can be matched with at least one second semantic query stored in the cache based on the first semantic metadata and second semantic metadata of each second semantic query; and in the cache, the first semantic query is marked by the first semantic metadata.

In some embodiments, when achieving graph data linked with at least one matched second semantic query from the cache, if the first semantic query's result is composed of at least two second queries' results, combining graph data linked respectively with the matched at least two second queries; or if the first semantic query's result is a subset of at least one second semantic query's result, achieving graph data from the minimum of the matched at least one second semantic query's result. With the solution provided, graph data can be achieved from the cache, although there is no exactly matched result. And achieving the graph data from the minimum of the matched at least one second semantic query's result can effectively reduce calculation of the subset from the at least one second semantic query's result.

In some embodiments, there can be at least two semantic elements, according to predefined weight of each semantic element, the higher the weight, the higher priority the semantic element is taken into account when achieving graph data from the minimum of the matched at least one second semantic query's result. With the solution provided, different semantic elements have different weights, then engineers can flexibly define the weights according to different application scenarios which value different weights of semantic elements.

In some embodiments, before matching the first semantic query with at least one second semantic query in the cache based on each first value of the at least one semantic element, hash of the first semantic query can be calculated, if the hash of the third semantic query out of the at least one second semantic query is same with hash of the first semantic query, then graph data linked with a third semantic query from the cache can be achieved; if none of hash of the at least one second semantic query is same with hash of the first semantic query, then matching the first semantic query with at least one second semantic query stored in the cache based on each first value of the at least one semantic element. With the solution provided, with hash of each second semantic query, an exact match can be first done, and if matched, an exact same graph data can be achieved directly.

In some embodiments, whether graph data in the database is updated can be detected, once detected, all queries in the cache related to the updated graph data will be invalidated. With the solution provided, the cached queries can be kept in consistence with graph data in the database, to ensure semantic query result from the cache updated.

In some embodiments, the at least semantic element comprises one or multiple of following items: entity, relationship, condition and target. With the solution provided, semantic elements can be extracted, which is helpful for graph data searching.

Hereinafter, above-mentioned and other features of the present techniques are described in detail. Various embodiments are described with reference to the drawing, where like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the scope of the disclosure. It may be evident that such embodiments may be practiced without these specific details.

When introducing elements of various embodiments of the present disclosure, the articles “a”, “an”, “the” and “said” are intended to mean that there are one or more of the elements. The terms “comprising”, “including” and “having” are intended to be inclusive and mean that there may be additional elements other than the listed elements.

FIG. 1 depicts a system 100 for graph data caching. As shown in FIG. 1, the system 100 can include: a cache 116; a database 117; and an apparatus 10 for graph data caching. Graph data is stored in the database 117, however, the cache 116 provides a fast access to the graph data. The cache 116 can be a memory inside or outside of the apparatus 10, it can also be other storage system. The cache 116, in comparison to a database, can be fast accessed.

Graph data can be knowledge graph data or other kinds of graph data wherein data is organized by graph. Graph data, such as knowledge graphs are widely used as one of the fundamental components in semantic web applications. They rely on the Knowledge Bases (KBs) to store complex-structure and unstructured data which are used by computer system. In KBs, data are stored as graph through vertices and edges to represent interactions and relationships between objects in various fields, such as social network analysis, bio-information system, and Internet of Things (IoT). Due to the irregular data access patterns in the graph computation, it remains a fundamental challenge to deliver highly efficient solutions for large scale graph queries and analytics. Such performance inefficiency greatly limits the application scenarios of many graph algorithms. Whereas in the present disclosure, graph data queries are based on semantic elements extracted from the queries, being matched with stored queries and linked graph data in cache, fast and concise graph data access can be achieved.

As shown in FIG. 1, Data from variant heterogeneous data sources 20 can be loaded by the data loader 41. Data collector 42 can accept raw data from the data loader 41 and extract knowledge according to predefined knowledge ontology. The extracted knowledge data can be persisted into graph database 117 via graph database accessor 43 which is the access interface to graph database 117.

A first semantic query 31 on the graph data can be sent by an external system 50 and received by the apparatus 10. From the first semantic query 31, semantic elements can be extracted and based on which the first semantic query 31 can be matched with second queries 32 already stored in the cache 116. If matched, graph data of the matched second semantic query can be achieved from the cache 116. In comparison to achieving data from database 117, the data access speed is faster. Also in comparison to current in-memory caching system, the data access is based on semantic elements extracted from the first semantic query, complicated graph data can be matched precisely and be achieved.

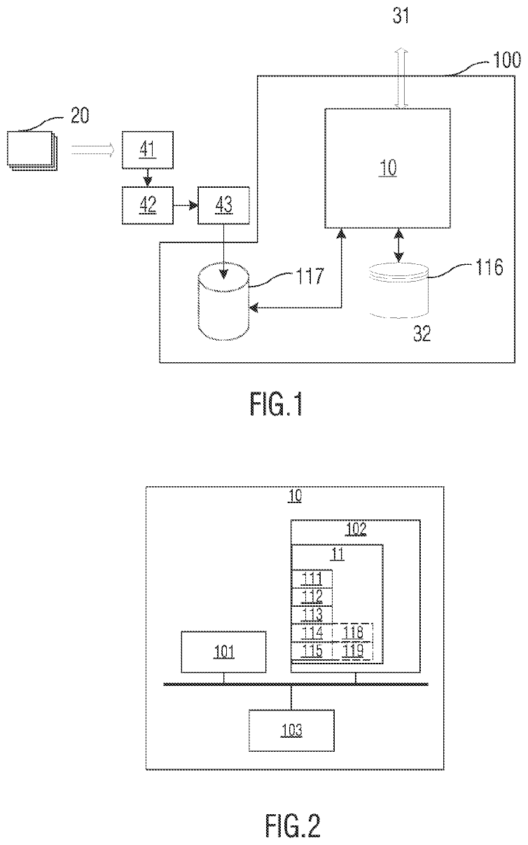

Details of functions and processing of the apparatus 10 and the system 100 will be described in combination with FIG. 2˜FIG. 5. FIG. 2 depicts a block diagram of the apparatus 10 for graph data caching incorporating teachings of the present disclosure. The apparatus 10 for graph data caching presented in the present disclosure can be implemented as a network of computer processors, to execute the method 200 at the side of the apparatus 10. The apparatus 10 can also be a single computer, as shown in FIG. 2, including at least one memory 102, which includes computer-readable medium, such as a random access memory (RAM). The apparatus 10 also includes at least one processor 101, coupled with the at least one memory 102.

Computer-executable instructions are stored in the at least one memory 102, and when executed by the at least one processor 101, can cause the at least one processor 101 to perform the steps described herein. The at least one processor 101 may include a microprocessor, an application specific integrated circuit (ASIC), a digital signal processor (DSP), a central processing unit (CPU), a graphics processing unit (GPU), state machines, etc. embodiments of computer-readable medium include, but not limited to a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable medium may transmit or carry instructions to a computer, including a router, private or public network, or other transmission device or channel, both wired and wireless. The instructions may include code from any computer-programming language, including, for example, C, C++, C#, Visual Basic, Java, and JavaScript.

The at least one memory 102 shown in FIG. 2 can contain a graph data caching program 11 when executed by the at least one processor 101, causing the at least one processor 101 to execute the method 200. The graph data caching program 11 can include a receiving unit 111, a semantic parser 112, a query analyzer 113, a query executor 114, a cache manager 115.

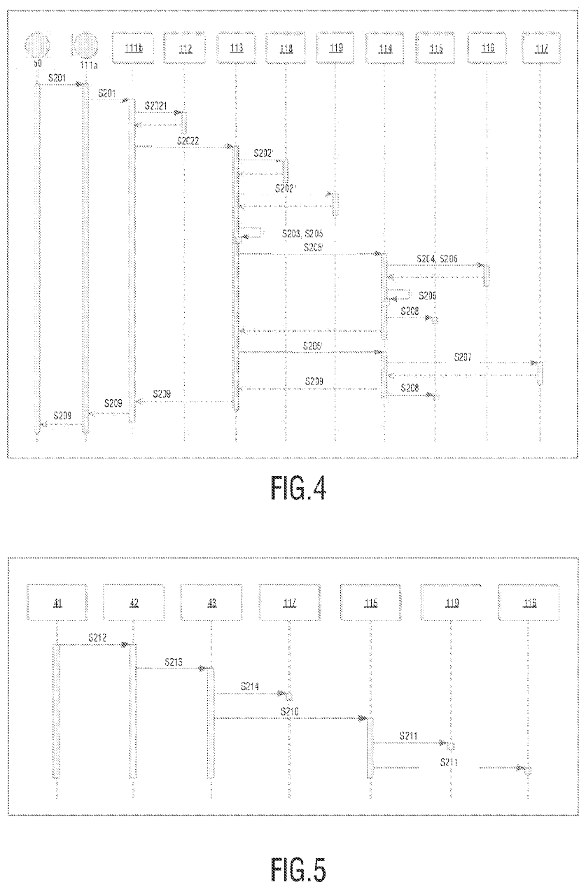

Referring to FIG. 4, the receiving unit 111 can be configured to receive a first semantic query 31 on graph data from an external system 50. In some embodiments, the receiving unit 111 can include an API 111a and a service 111b, the API 111a can be an external data service interface, which accepts the first semantic query 31 from the external system 50 and forwards to the service 111b. Depending on whether the graph cache function provided in the present disclosure is enabled, the service 111b can decide whether to use the graph cache function to accelerate graph data acquisition. If graph cache function is enabled, the service 111b will call the semantic parser 112 to perform semantic analysis on the first semantic query 31.

The semantic parser 112 can be configured to perform semantic analysis on the first semantic query 31, extract at least one semantic element and send to the query analyzer 113 to generate query execution plan.

The query analyzer 113 can generate query execution plan directly based on the extracted semantic element(s) or have the at least one semantic element mapped to semantic metadata and generate query execution plan based on the mapped metadata. For the latter option, the apparatus 10 can further include a metadata controller 118 which defines semantic metadata.

The query analyzer 113 can use the semantic metadata or the extracted at least one semantic element to match the stored at least one second query 32 in the cache 116. In some embodiments, the apparatus 10 can further include an index manager 119, which manages indexes of all the queries stored in the cache 116. The query analyzer 113 can query the index manager 119 to check whether the cache 116 can provide graph data required by the first semantic query 31. Depending on result of cache query, the query analyzer 113 can generate a query execution plan and send the execution plan to the query executor 114.

The query executor 114 can obtain the required graph data either from the cache 116 or from database 117 or a combination of them.

The cache manager 115 can store in the cache 116 the first semantic query 31 and the achieved graph data, and in the cache 116, the first semantic query 31 is linked with the achieved graph data. In some embodiments, the first semantic query 31 can be marked by each first value or the first semantic metadata. furthermore, the cache manager 115 can also manage indexes of each query stored in the cache 116 and implement functionalities of cache capacity management, cache replacement and invalidation as well as the statistics information collection.

In some embodiments, when generating and executing the query execution plan, if the first semantic query's result is composed of at least two second queries' results, then graph data linked respectively with the matched at least two second queries can be combined; or if the first semantic query's result is a subset of at least one second semantic query's result, graph data can be achieved from the minimum of the matched at least one second semantic query's result. When there are at least two semantic elements, according to predefined weight of each semantic element, the higher the weight, the higher priority the semantic element is taken into account.

In some embodiments, the query analyzer 113 can first calculate hash of the first semantic query; if hash of the third semantic query out of the at least one second semantic query is same with hash of the first semantic query, the query executor 114 can achieve from the cache 116 graph data linked with a third semantic query. Otherwise, if none of hash of the at least one second semantic query 32 is same with hash of the first semantic query 31, the query analyzer 113 can match the first semantic query 31 with at least one second semantic query 32 stored in the cache 116 based on each first value of the at least one semantic element.

Functions of modules of the apparatus 10 and interactions of modules are introduced as above. Now an example of semantic query in cache will be introduced.

In the present disclosure, semantic queries including the first semantic query 31, and below mentioned second queries 32 allow for queries and analytics of associative and contextual nature. Semantic queries can work on named graphs, linked data or triples which enables semantic queries to process the actual relationships between information and infer answers from the network of data. Semantic query languages e.g. SPARQL to triple store, Gremlin or Cypher to native graph database have the similar structure with SQL query language. In cache system, it can only processing query statements. The modifying statements must be processed in real graph database. When we discuss semantic metadata, we only discuss query statements.

In SQL, semantic query (or it can be called as “semantic query statement”) can be in the following form:
SELECT something FROM some table WHERE some conditions are satisfied

Similarly, in Cypher, the query language has the following structure:
MATCH some entities and their relationships WHERE some conditions
RETURN some entities and relationships

For different semantic query languages,, semantic metadata defines the language characteristics of the corresponding query statements. Take Cypher as an example, the semantic metadata definition consists of a set of entities E and relationships R, and some conditions C, and returned target T. So, a semantic query statement in Cypher can be labelled as SQ=(E,R,C,T). The semantic metadata in Cypher mainly includes the above defined the set of E,R,C,T.

A semantic query statement SQ will firstly go through semantic parsing by semantic parser 112, metadata mapping by metadata controller 118 and cache index searching by index manager 119. The query results might be provided by the following steps:

MD5 hash value of each query is stored together with respective query and the corresponding graph data in the cache 116. The query analyzer 113 can compare the MD5 hash to check if the exactly matched query exists. If the same query exists, graph data can be returned directly from the cache 116.

When there is no exact matched query, it will be checked if there is super query SQₛᵤₚₑᵣ⊇SQ which means Eₛᵤₚₑᵣ⊇E∧Rₛᵤₚₑᵣ⊇R∧Cₛᵤₚₑᵣ⊇C∧Tₛᵤₚₑᵣ⊇T. If there are multiple cache results [SQₛᵤₚₑᵣ], the minimal of SQₛᵤₚₑᵣ will be returned. The super query results must be filtered to meet the target query. The minimal of SQₛᵤₚₑᵣ means the minimal of Eₛᵤₚₑᵣ, Rₛᵤₚₑᵣ, Cₛᵤₚₑᵣ, Tₛᵤₚₑᵣ and Eₛᵤₚₑᵣ>Rₛᵤₚₑᵣ>Cₛᵤₚₑᵣ>Tₛᵤₚₑᵣ.

Also, when there is no exact matched query, it will be checked if there is sub query SQ_{sub}⊇SQ. For sub query results, only if the combination of sub queries can provide all results requested by target query SQ, the cached sub query results [SQ_{sub}] will be used. If there are multiple options by combining sub queries can meet the target query, the system needs to evaluate the candidate sub queries to choose the most suitable result. The measurement of results depends on which combination returns the least amount of data.

If there is no matched query in the cache 116, graph data will be returned from the database 117.

In some embodiments, referring to FIG. 5, the cache manager 115 can be further configured to detect graph data in the database is updated, and invalidate all queries in the cache related to the updated graph data.

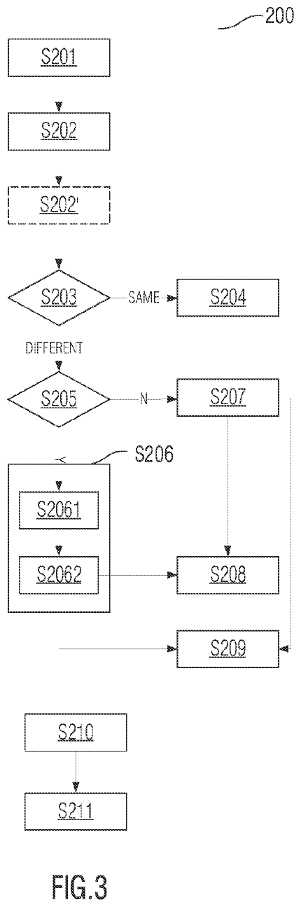

The modules are described above as software modules of the graph data caching program 11. Also, they can be implemented via hardware, such as ASIC chips. They can be integrated into one chip, or separately implemented and electrically connected. The present disclosure may include apparatuses having different architecture than shown in FIG. 2. The architecture above is merely exemplary and used to explain the exemplary method 200 shown in FIG. 3.

FIG. 3 depicts a flow diagram of a method for graph data caching incorporating teachings of the present disclosure. As shown in FIG. 3, FIG. 4 and FIG. 5, the method 200 can include: S201: receiving a first semantic query 31 on graph data; and S202: extracting, from the first semantic query 31, each first value of at least one semantic element.

In some embodiments, in sub step S2021 of the step S202, the service 111b calls the semantic parser 112 to perform semantic analysis on the first semantic query 31, and the semantic parser 112 performs semantic analysis on the first semantic query 31, extracting at least one semantic element. In sub step S2022, the at least one semantic element is sent to the query analyzer 113 via the service 111b.

In some embodiments, in step S202′, the query analyzer 113 sends the at least one semantic element to the metadata controller 118, the metadata controller 118 returns with the mapped metadata. then in following steps, the query analyzer 113 can match the first semantic query 31 with at least one second semantic query 32 based on the mapped metadata. Or the query analyzer 113 can match based on the at least one semantic element directly.

In some embodiments, in step S202″, the query analyzer 113 can query the index manager 119 to check whether the cache 116 can provide graph data required by the first semantic query 31. If so, the procedure will proceed with following step S203.

The method 200 may include S203: calculating hash of the first semantic query 31; if hash of the third semantic query out of the at least one second semantic query is same with hash of the first semantic query 31, then proceed with following step S204, otherwise, proceed with following step S205; S204: achieving from the cache 116 graph data linked with a third semantic query 31; and S205: matching the first semantic query 31 with at least one second semantic query 32 stored in the cache 116 based on each first value of the at least one semantic element; if matches, proceed with following step S206, otherwise, proceed with following step S207.

In some embodiments, in step S205′, the query analyzer 113 can notify the query executor 114 to execute query execution plan according to judgement made by the query analyzer 113.

The method 200 may include S206: achieving graph data linked with at least one matched second semantic query from the cache 116. In some embodiments, if the first semantic query's result is composed of at least two second queries' results, in sub step S2061 of the step S206, graph data linked respectively with the matched at least two second queries is combined; or if the first semantic query's result is a subset of at least one second semantic query's result, in sub step S2062 of the step S206, graph data from the minimum of the matched at least one second semantic query's result is achieved.

The method 200 may include S207: achieving graph data from a database 117; S208: storing, in the cache 116, the first semantic query 31 and the achieved graph data, wherein the first semantic query 31 is linked with the achieved graph data; S209: returning graph data in response to the first semantic query 31; S212: loading data by the data loader 41 into the database 117; S213: extracting knowledge data by the data collector 42 from the raw data according to predefined knowledge ontology; S214: persisting by graph database accessor 43 the extracted knowledge data into the database 117; S210: detecting that graph data in the database 117 is updated; and S211: invalidating all queries in the cache related to the updated graph data.

In some embodiments, a computer-readable medium stores computer-executable instructions, wherein the computer-executable instructions when executed cause at least one processor to execute steps of one or more of the methods provided in the present disclosure.

In some embodiments, a computer programming product includes computer-readable instructions, wherein the computer-executable instructions cause at least one processor to execute one or more of the methods provided in the present disclosure.

While the present technique has been described in detail with reference to certain embodiments, it should be appreciated that the present technique is not limited to those precise embodiments. Rather, in view of the present disclosure which describes exemplary modes for practicing the teachings herein, many modifications and variations would present themselves, to those skilled in the art without departing from the scope and spirit of this disclosure. The scope is, therefore, indicated by the following claims rather than by the foregoing description. All changes, modifications, and variations coming within the meaning and range of equivalency of the claims are to be considered within their scope.

What is claimed is:

1. A method for graph data caching, the method comprising:
receiving a first semantic query on graph data;
extracting, from the first semantic query, each first value of at least one semantic element;
matching the first semantic query with at least one second semantic query stored in the cache based on each first value of the at least one semantic element;
if the first semantic query has a match, achieving graph data linked with the at least one matched second semantic query from the cache, otherwise, achieving graph data from a database;
storing, in the cache, the first semantic query and the achieved graph data, wherein the first semantic query is linked with the achieved graph data.

2. The method according to claim 1, wherein
matching the first semantic query with at least one second semantic query stored in the cache based on each first value of the at least one semantic element comprises matching the first semantic query with at least one second semantic query stored in the cache based on each first value of the at least one semantic element and each second value of the least one semantic element of each second semantic query; and
wherein, in the cache, the first semantic query is marked by each first value.

3. The method according to claim 1, further comprising:
before matching the first semantic query with at least one second semantic query stored in the cache based on each first value of the at least one semantic element, mapping each first value of the at least one semantic element on first semantic metadata, wherein semantic metadata comprises the at least one semantic element;
wherein matching the first semantic query with at least one second semantic query stored in the cache based on each first value of the at least one semantic element comprises matching the first semantic query with at least one second semantic query stored in the cache based on the first semantic metadata and second semantic metadata of each second semantic query; and
in the cache, the first semantic query is marked by the first semantic metadata.

4. The method according to claim 1, wherein achieving the graph data linked with at least one matched second semantic query from the cache comprises:
if the first semantic query's result is composed of at least two second queries' results, combining graph data linked respectively with the matched at least two second queries; or if the first semantic query's result is a subset of at least one second semantic query's result, achieving graph data from the minimum of the matched at least one second semantic query's result.

5. The method according to claim 4, wherein there are at least two semantic elements, achieving graph data from the minimum of the matched at least one second semantic query's result comprises:
according to predefined weight of each semantic element, the higher the weight, the higher priority the semantic element is taken into account when achieving graph data from the minimum of the matched at least one second semantic query's result.

6. The method according to claim 1, further comprising
before matching the first semantic query with at least one second semantic query in the cache based on each first value of the at least one semantic element, the method further comprises:
calculating hash of the first semantic query;
achieving from the cache graph data linked with a third semantic query, if hash of the third semantic query out of the at least one second semantic query is same with hash of the first semantic query; and
matching the first semantic query with at least one second semantic query stored in the cache based on each first value of the at least one semantic element comprises: if none of hash of the at least one second semantic query is same with hash of the first semantic query, matching the first semantic query with at least one second semantic query stored in the cache based on each first value of the at least one semantic element.

7. The method according to claim 1, further comprising:
detecting updated graph data in the database; and
in response, invalidating all queries in the cache related to the updated graph data.

8. The method according to claim 1, wherein the at least semantic element comprises one or multiple of following items:
entity;
relationship;
condition; and
target.

9. An apparatus for graph data caching, the apparatus comprising:
a receiving unit to receive a first semantic query on graph data;
a semantic parser to extract from the first semantic query each first value of at least one semantic element;
a query analyzer to match the first semantic query with at least one second semantic query stored in the cache based on each first value of the at least one semantic element;
a query executor to, if matches achieve graph data linked with at least one matched second semantic query from the cache, otherwise, achieve graph data from a database; and
a cache manager to store in the cache the first semantic query and the achieved graph data, wherein the first semantic query is linked with the achieved graph data.

10. The apparatus according to claim 9, wherein
the query analyzer is further configured to match the first semantic query with at least one second semantic query stored in the cache based on each first value of the at least one semantic element and each second value of the least one semantic element of each second semantic query; and
in the cache, the first semantic query is marked by each first value.

11. The apparatus according to claim 9,
further comprising:
a metadata controller to before the query analyzer matches the first semantic query with at least one second semantic query stored in the cache based on each first value of the at least one semantic element, map each first value of the at least one semantic element on first semantic metadata, wherein semantic metadata comprises the at least one semantic element;
wherein the query analyzer is further configured to match the first semantic query with at least one second semantic query stored in the cache based on the first semantic metadata and second semantic metadata of each second semantic query; and
in the cache, the first semantic query is marked by the first semantic metadata.

12. The apparatus according to claim 9, wherein the query executor is further configured to:
if the first semantic query's result is composed of at least two queries' combine second results, graph data linked respectively with the matched at least two second queries; or
if the first semantic query's result is a subset of at least one second semantic query's result, achieve graph data from the minimum of the matched at least one second semantic query's result.

13. The apparatus according to claim 12, wherein there are at least two semantic elements, and the query executor is further configured to,
according to a predefined weight of each semantic element, the higher the weight, the higher priority the semantic element is taken into account.

14. The apparatus according to claim 9, wherein:
before matching the first semantic query with at least one second semantic query in the cache based on each first value of the at least one semantic element,
the query analyzer is configured to calculate hash of the first semantic query;
the query executor is configured to achieve from the cache graph data linked with a third semantic query, if hash of the third semantic query out of the at least one second semantic query is same with hash of the first semantic query; and
the query analyzer is further configured to, if none of hash of the at least one second semantic query is same with hash of the first semantic query, match the first semantic query with at least one second semantic query stored in the cache based on each first value of the at least one semantic element.

15. The apparatus according to claim 9, wherein the cache manager is further configured to:
detect updated graph data in the database; and
invalidate all queries in the cache related to the updated graph data.

16. The apparatus according to claim 9, wherein the at least one semantic element comprises one or multiple of following items:
entity;
relationship;
condition; and
target.

17. An apparatus for graph data caching, the apparatus comprising:
at least one processor;
at least one memory coupled to the at least one processor (101), the at least one memory storing computer-executable instructions, wherein the computer-executable instructions when executed cause the at least one processor to:
receive a first semantic query on graph data;
extract, from the first semantic query, each first value of at least one semantic element;
match the first semantic query with at least one second semantic query stored in the cache based on each first value of the at least one semantic element;
if the first semantic query has a match, achieve graph data linked with the at least one matched second semantic query from the cache, otherwise, achieve graph data from a database;
store, in the cache, the first semantic query and the achieved graph data, wherein the first sematic query is linked with the achieved graph data.

18-19. (canceled)

20. A system for graph data caching, comprising:
a cache;
a database; and
an apparatus for graph data caching, the apparatus comprising:
a receiving unit to receive a first semantic query on graph data;
a semantic parser to extract from the first semantic query each first value of at least one semantic element;
a query analyzer to match the first semantic query with at least one second semantic query stored in the cache based on each first value of the at least one semantic element;
a query executor to, if matches achieve graph data linked with at least one matched second semantic query from the cache, otherwise, achieve graph data from a database; and
a cache manager to store in the cache the first semantic query and the achieved graph data, wherein the first semantic query is linked with the achieved graph data.
